(19) United States
(12) Patent Application Publication
(10) Pub. No.: US 2013/0205739 A1
(43) Pub. Date: Aug. 15, 2013

(54) WALK REEL MOWER WITH EASILY DEPLOYABLE KICKSTAND

(71) Applicants: Robert D. Patton, New Prague, MN (US); Thomas F. Langworthy, Henderson, MN (US)

(72) Inventors: Robert D. Patton, New Prague, MN (US); Thomas F. Langworthy, Henderson, MN (US)

(21) Appl. No.: 13/369,474

(22) Filed: Feb. 9, 2012

(51) Int. Cl. A01D 34/53

(52) U.S. Cl. 56/249

(57) ABSTRACT

A walk reel mower has a traction frame that carries a reel cutting unit and that is self-propelled over the ground by a traction drum that is operatively connected to a power source on the traction frame. A U-shaped kickstand at the rear of the traction frame has a raised, inoperative position in which the kickstand is substantially nested within the rearwardly and upwardly extending handle tubes of a handle assembly. The kickstand is pivotally connected to the traction frame to pivot to a lowered, fully deployed position in which the kickstand has engaged the ground and lifted the traction drum out of contact with the ground. The kickstand has an assist member that lies in a plane that is different from and that is inclined to a plane that encompasses the U-shape of the kickstand to allow the operator to apply leverage to the kickstand.

### TECHNICAL FIELD

This invention relates to mowers for cutting grass and, more particularly, to a walk reel mower having a kickstand for raising the traction drum off the ground and for supporting the mower in the drum raised position.

### BACKGROUND OF THE INVENTION

Walk reel mowers are known for the precision cutting of grass to very low heights of cut. Such mowers are most commonly used for cutting the grass on the greens of golf courses and thus are typically referred to as greensmowers. The mower includes a reel cutting unit having a rotatable reel that sweeps the grass against a sharpened bedknife for cutting the grass between the blades of the reel and the bedknife. The mower is self-propelled by a power source carried on the mower which is operatively connected to a rotatable, ground engaging traction drum carried on the mower.

The traction drum is used when the mower is being used for mowing, but is not used when the mower is in a transport mode such as when moving from one green on the golf course to another green. In this case, transport wheels having rubber tires are desirably installed on axle shafts that stick out from either side of the transport drum. To facilitate the installation and removal of the transport tires, greensmowers usually have a kickstand that can be swung down into engagement with the ground. Then, the operator pulls the greensmower rearwardly and lifts the greensmower upwardly over the kickstand while pressing down with one foot on the crossbar of the kickstand until the kickstand pivots over center. At this point, the greensmower becomes stably supported on the kickstand in a tilted position with the traction drum having been raised up off the ground far enough to allow the transport wheels to be easily installed on or removed from the axle shafts.

However, one problem with greensmowers is the difficulty the operator experiences in pulling the greensmower back and lifting it upwardly over the kickstand until the point in time when the kickstand pivots over center. Greensmowers are heavy and the act of pulling the greensmower up is done using upper body strength alone. Many operators may not be able to do it or at least have to significantly exert themselves to accomplish it by using brute force to muscle the greensmower up and back over the kickstand. Accordingly it would be advance in the art to provide a greensmower with a kickstand that could be deployed with less effort.

### SUMMARY OF THE INVENTION

One aspect of this invention relates to a walk reel mower for cutting grass. The mower comprises a traction frame which carries a power source. At least one ground engaging traction member is rotatably carried on the traction frame and is operatively connected to the power source for self-propelling the traction frame over the ground. A reel cutting unit is carried on the traction frame. An upwardly and rearwardly extending handle assembly is connected to the traction frame and has a hand grip to permit an operator who walks on the ground behind the handle assembly to guide the traction frame by holding the hand grip. A kickstand is carried at the rear of the traction frame for movement between a raised, inoperative position in which the kickstand is out of contact with the ground and a lowered, fully deployed position in which the kickstand is engaged with the ground and supports the traction member off the ground. The kickstand has a cross bar which is pivotally connected to the traction frame for rotation about a substantially horizontal pivot axis. The kickstand includes an assist member that projects from the crossbar in a manner such that the assist member does not lie within a plane encompassing the pivot axis and the cross bar. The assist member is shaped and oriented to provide a surface against which an operator can push with a foot during at least a portion of the movement of the kickstand between the inoperative and fully deployed positions of the kickstand.

Another aspect of this invention relates to a walk reel mower which comprises a traction frame that carries a reel cutting unit. The traction frame is self-propelled over the ground by a traction drum that is operatively connected to a power source on the traction frame. A kickstand having a raised, inoperative position is provided in which the kickstand is proximate to a rearwardly and upwardly extending handle assembly attached to the traction frame. The kickstand is pivotally connected to the traction frame to pivot from the raised, inoperative position to a lowered, fully deployed position in which the kickstand has pivoted downwardly away from the handle assembly and has engaged the ground and lifted the traction drum out of contact with the ground. The kickstand has an assist member that lies in a plane that is different from and that is inclined at an angle to a plane that encompasses the kickstand to allow the operator to apply leverage to the kickstand during the deployment thereof.

### BRIEF DESCRIPTION OF THE DRAWINGS

This invention will be described in the following Detailed Description when taken in conjunction with the drawings in which like reference numerals refer to like elements throughout.

FIG. 1 is a perspective view of a first embodiment of a mower according to this invention;

FIG. 2 is a perspective view from the front of the mower of FIG. 1, particularly illustrating the mower with various portions thereof removed to more clearly show the kickstand with the kickstand being located in a raised, inoperative position thereof;

FIG. 3 is a perspective view from the rear of the mower of FIG. 1, particularly illustrating the kickstand in the raised, inoperative position thereof as well as a lift assist handle located at the bottom of the control panel carried on the handle assembly of the mower;

FIG. 4 is a side elevational view of the mower of FIG. 1, particularly illustrating the kickstand in the raised inoperative position thereof;

FIG. 5 is a side elevational view similar to FIG. 4, particularly illustrating the kickstand in a midpoint position as it is being deployed; and

FIG. 6 is a side elevational view similar to FIG. 4, particularly illustrating the kickstand in a fully deployed position with the kickstand supporting the mower in an upwardly inclined position with the traction drum having been raised off the ground.

### DETAILED DESCRIPTION

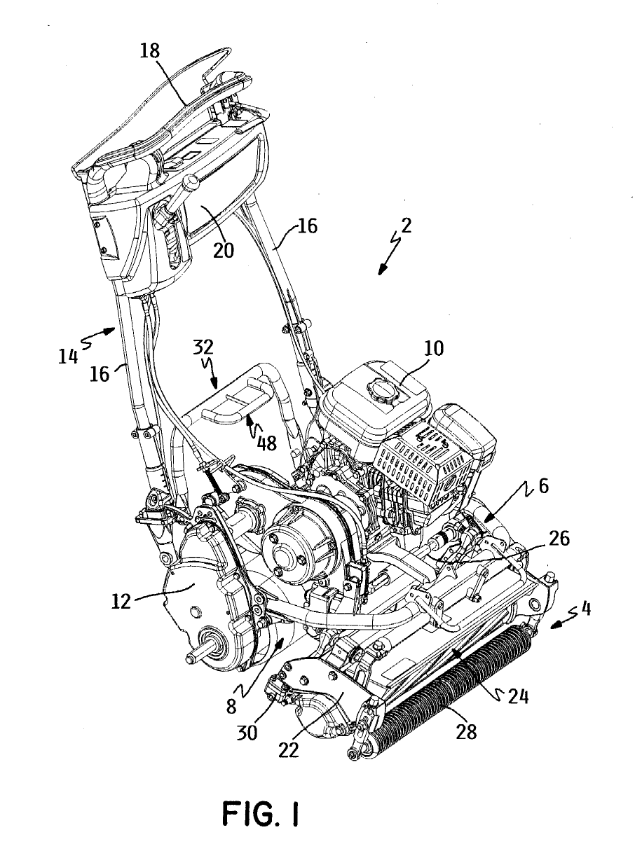

A mower according to this invention is generally illustrated as 2 in FIG. 1. Mower 2 preferably comprises a walk greensmower having a reel cutting unit 4 for precision mowing of grass at low heights of cut on golf course greens or the like.

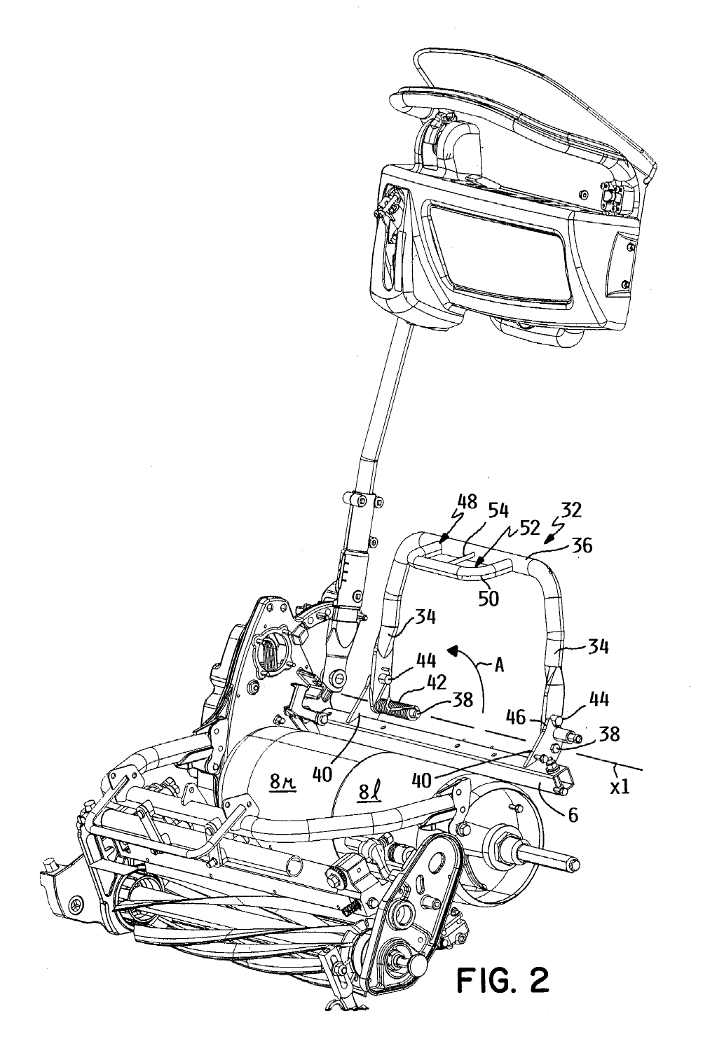

Referring to FIGS. 1 and 2, mower 2 comprises a traction frame 6 that is supported by a ground engaging traction drum 8 which is split into separate left and right drum halves 8l and 8r. Traction frame 6 mounts a power source comprising an internal combustion engine 10 or alternatively an electric motor (not shown). Engine 10 is operatively coupled to traction drum 8 through a traction drive system 12 for rotating traction drum 8 when engine 10 is operating to self-propel mower 2 over the ground. Traction drive system 12 includes a differential (not shown) that is built into traction drum 8 for allowing the left and right drum halves 8l and 8r to rotate at different speeds during turns of mower 2.

A generally U-shaped upwardly and rearwardly extending handle assembly 14 is provided at the rear of traction frame 6 to allow an operator who walks on the ground behind traction frame 6 to guide and manipulate mower 2 during operation of mower 2. Handle assembly 14 includes laterally spaced left and right handle tubes 16 that are attached at their lower ends to opposite sides of traction frame 6. Handle tubes 16 are joined together at their upper ends by a laterally extending hand grip 18 which the operator can hold onto when operating mower 2. A control panel 20 is fixed to and extends between the upper ends of handle tubes 16 and is located slightly below hand grip 18.

Traction frame 6 mounts cutting unit 4 thereon in advance of engine 10 and in advance of traction drum 8. Cutting unit 4 comprises a cutting unit frame 22 that carries a helically bladed reel 24 that is journalled between spaced side plates of cutting unit frame 22 for rotation about a substantially horizontal axis. A bedknife is fixed to cutting unit frame 22 below and closely adjacent to the outer diameter of reel 24 so that grass is cut by a shearing action when the blades of reel 24 sweep uncut stalks of grass against a sharpened front edge of the bedknife. A cutting reel drive system 26 operatively powers reel 24 from engine 10. Cutting unit frame 22 is supported by its own front and rear ground engaging rollers 28 and 30, respectively.

Cutting unit 4 at the front of mower 2 is pivotally coupled to traction frame 6 by a suspension system that allows cutting unit 4 to conform to ground contours independently of traction frame 6. More particularly, the suspension system provides cutting unit 4 with the ability to pitch fore-and-aft about a substantially horizontal, laterally extending pitch axis and to roll side-to-side about a substantially horizontal, longitudinally extending roll axis. U.S. Pat. No. 7,191,584, which is assigned to The Toro Company, the assignee of this invention, and which is hereby incorporated by reference, discloses a suspension system that can be used on mower 2 for providing pitch and roll to cutting unit 4.

This invention relates particularly to an improved kickstand 32 on mower 2. Kickstand 32 is generally U-shaped having a pair of laterally spaced legs 34 that are integrally joined at one end to a laterally extending crossbar 36. The opposite free ends of legs 34 are pivotally supported by a pair of pivots 38 to brackets 40 carried on traction frame 6. This permits kickstand 32 to pivot about a substantially horizontal pivot axis x1. See FIG. 2.

One pivot 38 is elongated along pivot axis x1 to mount a torsion spring 42 that normally biases kickstand 32 upwardly in a direction indicated by the arrow A in FIG. 2. The bias of spring 42 urges kickstand 32 into a raised, inoperative position, shown in FIGS. 1-3, in which kickstand 32 is nested between handle tubes 16 of handle assembly 14 in the same plane as handle tubes 16. Pins 44 on legs 34 of kickstand 32 abut with rearwardly facing lips 46 on brackets 40 to stop or retain kickstand in its raised, inoperative position to prevent spring 42 from urging kickstand 32 any further forwardly than is shown in FIGS. 1-3. In the raised inoperative position of kickstand 32, kickstand 32 is conveniently stored out of the way between handle tubes 16 during normal operation of mower 2.

Kickstand 32 includes an assist member 48 that is fixed to and that projects outwardly from a central portion of crossbar 36 such that assist member 48 does not lie within the plane that contains legs 34 and crossbar 36 of kickstand 32. Assist member 48 is formed as a U-shaped loop 50 defining an open space 52 in the interior of loop 50. Since assist member 48 will be engaged by the operator's foot during deployment of kickstand 32 as will be described in more detail hereafter, open space 52 includes a center brace 54 that prevents the operator from inserting the toes of his or her foot into open space 52. Alternatively, assist member 48 could simply comprise a relatively solid piece of material of the same general size and orientation relative to crossbar 36 rather than being a relatively open loop 50. In such a case, center brace 54 would not be needed.

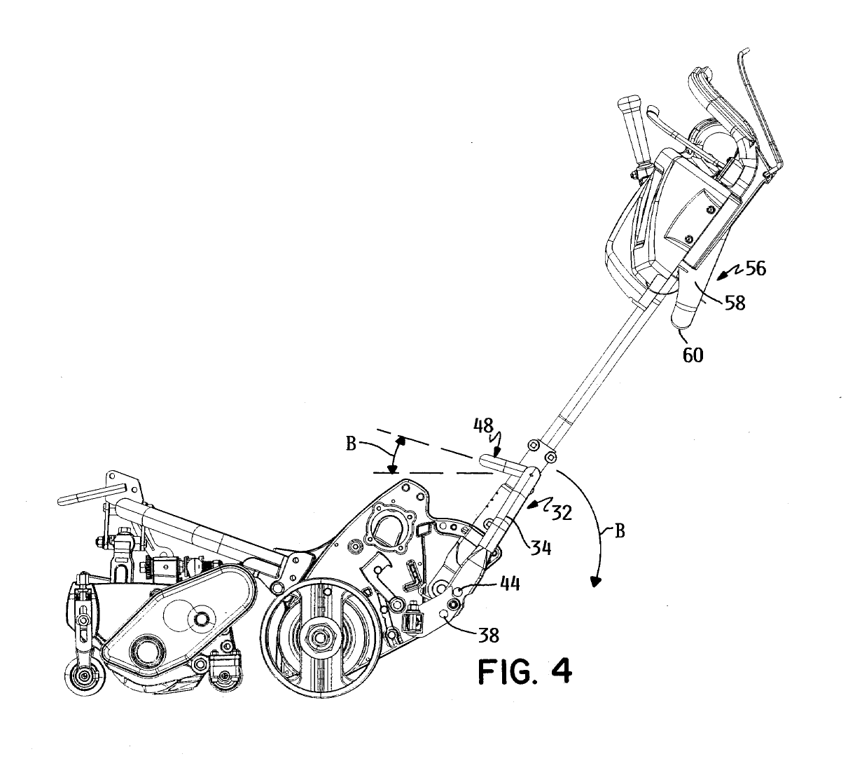

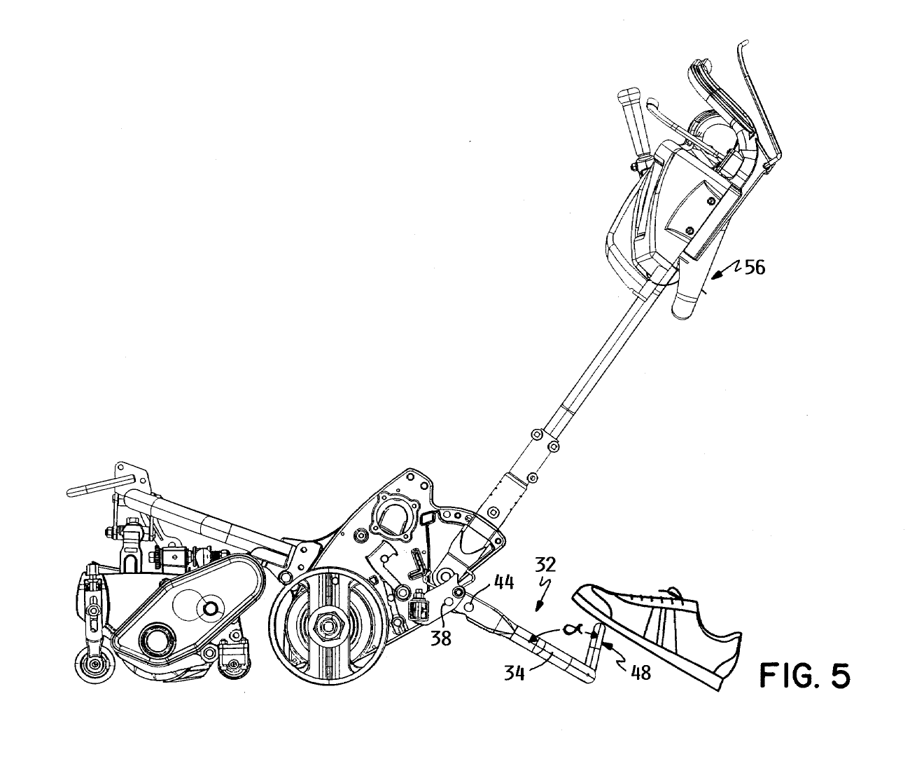

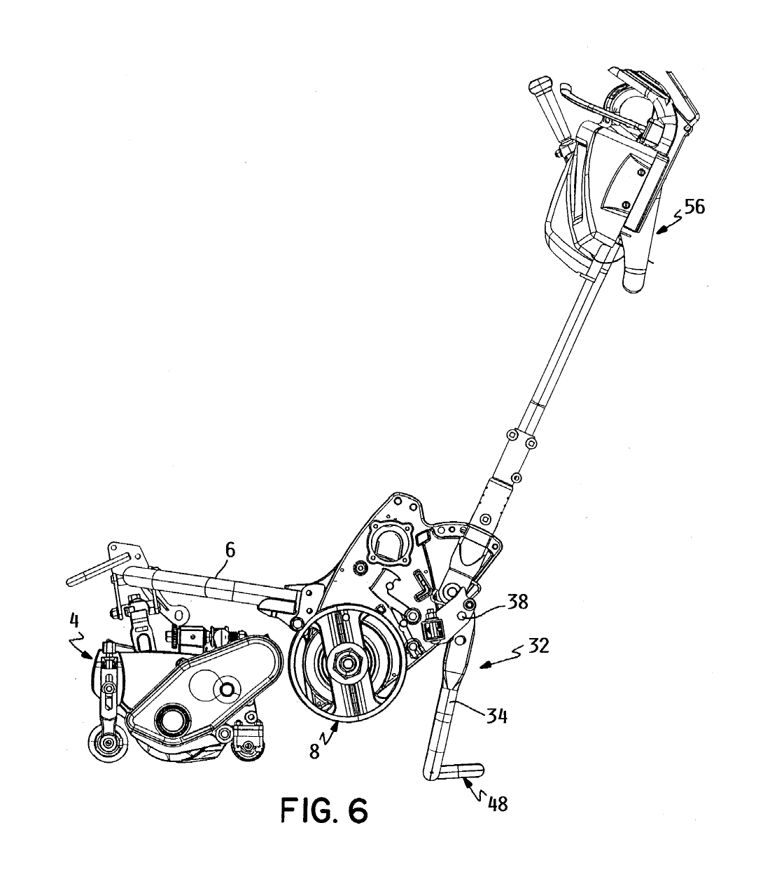

As best shown in FIG. 5, assist member 48 is disposed at an angle α of approximately 75° from the position it would have had if assist member 48 had been placed flat within the central interior of kickstand with assist member 48 being aligned in the same plane as legs 34 of kickstand 32. As kickstand 32 rotates about its pivots 38 from the raised, inoperative position thereof as shown in FIGS. 1-3 to a lowered, fully deployed position as shown in FIG. 6, kickstand 32 will move through a pivotal arc of approximately 180°. Since assist member 48 is a fixed portion of kickstand 32, assist member 48 will substantially change its orientation in concert with the rotation of the rest of kickstand 32. Originally, in the raised, inoperative position of kickstand 32, assist member 48 will be pointing forward and will be substantially horizontal or slightly upwardly inclined relative to horizontal as indicated by the angle β in FIG. 4. In the lowered, fully deployed position of kickstand 32 as shown in FIG. 6, assist member 48 will be pointing rearwardly and will be substantially horizontal to rest substantially flat atop the ground. Assist member 48 progressively changes its orientation at intermediate positions of kickstand 32.

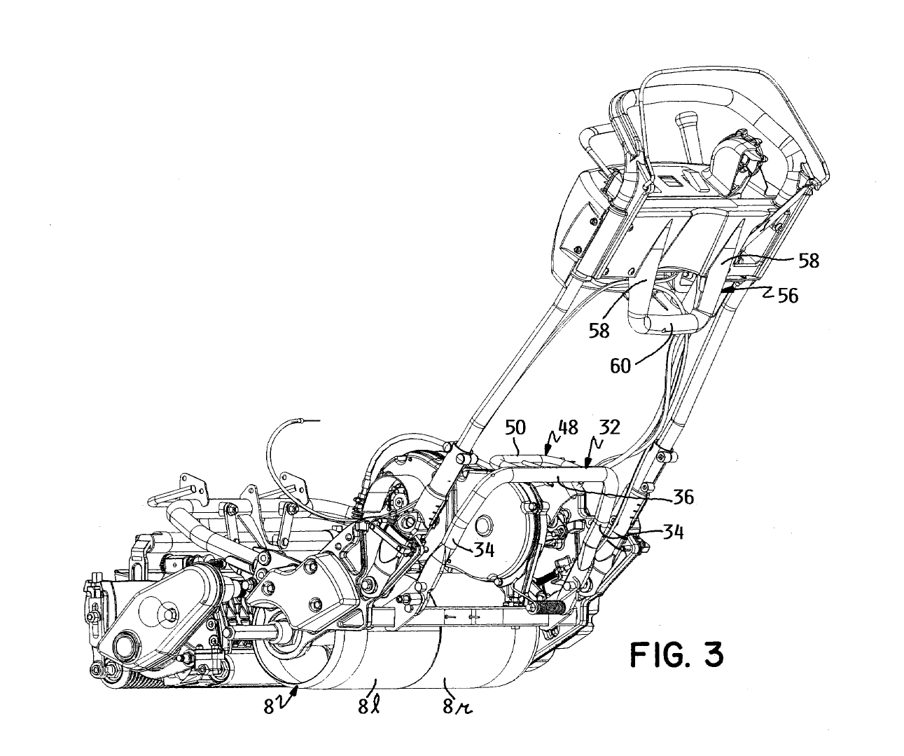

In addition to kickstand 32, a lift assist handle 56 is placed on the bottom of control panel 20 of handle assembly 14 in a centered position between handle tubes 16. See FIG. 3. Lift assist handle 56 has an upwardly facing U-shape defined by a pair of legs 58 that extend upwardly to attach to control panel 20 and a lateral hand grip 60 that is spaced beneath control panel 20 to be fairly low on handle assembly 14. Preferably, hand grip 60 is located approximately 15 inches below hand grip 18 of handle assembly 14. This position is designed such that when the operator grips hand grip 60 of lift assist handle 56, the operator's hands for an average sized operator will remain below the operator's beltline when the greatest amount of lifting effort is required. This lessens the load on the operator's lower back compared to prior art greensmowers having higher assist handles.

In deploying kickstand 32, the operator will approach mower 2 from behind handle assembly 14 and will use one foot on top of crossbar 36 on either side of assist member 48 to begin pivoting kickstand 32 rearwardly about its pivots 38 as shown by the arrow B in FIG. 4. This motion continues until crossbar 36 engages with the ground as shown in FIG. 5. At this point, the operator can shift his foot position or use the other foot to hold crossbar 36 on the ground by placing the heel of that foot on the ground behind crossbar 36 while stepping on top of assist member with the forward portion of that foot. Assist member 48 is substantially vertical at this midpoint position in the range of motion of kickstand 32. Thus, the operator can easily incline his or her foot upwardly to rest the toes or ball of the foot on top of assist member 48 while the heel remains on the ground. This foot position is illustrated in FIG. 5.

With the operator's foot in position atop assist member 48 as shown in FIG. 5, the operator can then take hold of hand grip 60 of lift assist handle 56 and pull rearwardly and lift upwardly on lift assist handle 56 while applying downward force to assist member 48 using the operator's inclined foot resting on top of assist member 48. As mower 2 begins to come back and rise, kickstand 32 will continue to pivot relative to traction frame 6 in the direction of arrow B. As this happens, assist member 48 will progressively become more horizontal and then provides a more and more horizontal pedal or step that gives the operator ever increasing leverage. Effectively, at this point assist member 48 provides an upwardly facing surface against which the operator can push with his or her foot. This allows the downward force being applied to assist member 48 by the operator's foot to actually apply torque to kickstand 32 in the direction of arrow B such that the downward force is not wasted but helps rotate kickstand around to its fully deployed position shown in FIG. 6.

In the fully deployed position of kickstand 32 as shown in FIG. 6, kickstand 32 has swung over center and now elevates traction drum 8 above the ground. Traction drum 8 is raised sufficiently so that transport wheels (not shown) can be installed on the axles shown extending outwardly from either side of traction drum 8. Hand grip 60 of lift assist handle 56 is approximately 25 inches above the ground when kickstand is in its raised, inoperative position. After kickstand 32 is fully deployed as shown in FIG. 6, hand grip 60 of lift assist handle 56 has been elevated to be approximately 33 inches above the ground.

The effect of assist member 48 is to dramatically ease the upper body effort needed by the operator to deploy kickstand 32. At the point where the most upper body effort is required, i.e. at a point about halfway through the kickstand positions shown in FIGS. 5 and 6, the assist member 48 forms enough of an upwardly facing surface that the operator's foot can supply significant torque to kickstand 32 by pushing downwardly against assist member 48. Thus, the overall work effort needed to lift mower 2 may be the same, but it is now split between upper body effort on lift assist handle 56 and lower body or leg drive on assist member 48. It is simply much easier on the operator to deploy kickstand 32 than is true of the kickstands found in prior art mowers which lack any member corresponding to assist member 48.

Various modifications of this invention will be apparent to those skilled in the art. For example, some kickstands 32 used on mowers 2 of this type have a T-shape rather than a U-shape where crossbar 36 is the horizontal top of the T-shape. Kickstand 32 disclosed herein could have such a T-shape with assist member 48 being connected to the crossbar forming portion of the T-shape. In addition, the size, shape and construction of assist member 48 can be varied from that shown. One alternative form of assist member 48 would be a substantially narrower pedal formed from sheet metal. Finally, handle assembly 14 could have other than a U-shape, such as a handle assembly with a central upwardly and rearwardly extending column with a bar or loop type hand grip at the top of the column.

In addition, assist member 48 could have a substantially horizontal rotational pivot at or near the central area of crossbar 36. This would allow the angle α to start out larger than currently illustrated. This would improve the initial mechanical advantage but when fully deployed this type of assist member 48 has to rotate out of the way to avoid premature contact with the turf (ground level). Thus, an assist member 48 that is fixed to crossbar 36 is preferred over one that pivots relative to cross bar 36 as such a fixed assist member adequately satisfies the need for providing mechanical advantage but is simplified in terms of manufacture and assembly.

Thus, the scope of this invention is to be limited only by the appended claims.

1. A walk reel mower for cutting grass, which comprises:
(a) a traction frame which carries a power source;
(b) at least one ground engaging traction member rotatably carried on the traction frame and operatively connected to the power source for self-propelling the traction frame over the ground;
(c) a reel cutting unit carried on the traction frame;
(d) an upwardly and rearwardly extending handle assembly connected to the traction frame and having a hand grip to permit an operator who walks on the ground behind the handle assembly to guide the traction frame by holding the hand grip;
(e) a kickstand carried at the rear of the traction frame for movement between a raised, inoperative position in which the kickstand is out of contact with the ground and a lowered, fully deployed position in which the kickstand is engaged with the ground and supports the traction member off the ground, wherein the kickstand has a cross bar which is pivotally connected to the traction frame for pivoting motion about a substantially horizontal pivot axis, wherein the kickstand includes an assist member that projects from the crossbar in a manner such that the assist member does not lie within a plane encompassing the pivot axis and the cross bar, the assist member being shaped and oriented to provide a surface against which an operator can push with a foot during at least a portion of the movement of the kickstand between the inoperative and fully deployed positions of the kickstand, wherein the assist member is oriented relative to the crossbar such that the assist member can be contacted by a foot of the operator and is substantially vertical when the crossbar first touches the ground at an intermediate position of the kickstand between the inoperative and fully deployed positions with the heel of the operator's foot engaging the ground behind the crossbar and with a forward portion of the operator's foot inclining upwardly from the ground to rest atop the assist member, and wherein the assist member becomes progressively more horizontal as the kickstand moves between the intermediate position of the kickstand and the fully deployed position of the kickstand such that the forward portion of the operator's foot can apply force to the crossbar by pushing downwardly on the assist member to apply torque to the kickstand tending to rotate the kickstand toward the fully deployed position.

2. (canceled)

3. The mower of claim 1, wherein the traction member comprises a rotatable drum.

4. A walk reel mower for cutting grass, which comprises:
(a) a traction frame which carries a power source;
(b) at least one ground engaging traction member rotatably carried on the traction frame and operatively connected to the power source for self-propelling the traction frame over the ground;
(c) a reel cutting unit carried on the traction frame;
(d) an upwardly and rearwardly extending handle assembly connected to the traction frame and having a hand grip to permit an operator who walks on the ground behind the handle assembly to guide the traction frame by holding the hand grip; and
(e) a kickstand carried at the rear of the traction frame for movement between a raised, inoperative position in which the kickstand is out of contact with the ground and a lowered, fully deployed position in which the kickstand is engaged with the ground and supports the traction member off the ground, wherein the kickstand has a cross bar which is pivotally connected to the traction frame for pivoting motion about a substantially horizontal pivot axis, wherein the kickstand includes an assist member that projects from the crossbar in a manner such that the assist member does not lie within a plane encompassing the pivot axis and the cross bar, the assist member being shaped and oriented to provide a surface against which an operator can push with a foot during at least a portion of the movement of the kickstand between the inoperative and fully deployed positions of the kickstand, wherein the assist member comprises a loop having a substantially open interior that is closed only partially by a substantially rigid central brace that lies substantially wholly within the open interior of the loop to prevent the operator from inserting his or her foot into the interior of the loop.

5. A walk reel mower, which comprises:
(a) a traction frame that carries a reel cutting unit and that is self-propelled over the ground by a traction drum that is operatively connected to a power source on the traction frame;
(b) a kickstand having a raised, inoperative position in which the kickstand is proximate to a rearwardly and upwardly extending handle assembly attached to the traction frame, wherein the kickstand is pivotally connected to the traction frame to pivot from the raised, inoperative position to a lowered, fully deployed position in which the kickstand has pivoted downwardly away from the handle assembly and has engaged the ground and lifted the traction drum out of contact with the ground, and wherein the kickstand has an assist member that comprises a fixed and substantially rigid portion of the kickstand with the assist member lying in a plane that is different from and that is inclined at an angle to a plane that encompasses the kickstand to allow the operator to apply leverage to the kickstand during the deployment thereof.
